(19) United States
(12) Patent Application Publication
(10) Pub. No.: US 2009/0152043 A1
(43) Pub. Date: Jun. 18, 2009

(54) Mounting Structure of Fuel Tank of Compressed Natural Gas Bus

(75) Inventor: Sangkyu LEE, Jeonbuk (KR)

Correspondence Address: MORGAN, LEWIS & BOCKIUS LLP (SF), One Market, Spear Street Tower, Suite 2800, San Francisco, CA, 94105, US

(73) Assignee: HYUNDAI MOTOR COMPANY, Seoul (KR)

(21) Appl. No.: 12/331,145

(22) Filed: Dec. 9, 2008

(30) Foreign Application Priority Data
Dec. 15, 2007 (KR) 10-2007-0131810

(51) Int. Cl. B60K 15/07; B60K 15/03

(52) U.S. Cl. 180/314; 280/834

(57) ABSTRACT

A mounting structure of a fuel tank may include a carrier fixed and mounted onto a roof panel of a vehicle body, fuel tanks sequentially arranged in a longitudinal direction of the vehicle body, wherein both end portions of each fuel tank are configured to be aligned in a traverse direction of the vehicle body, and fastening members coupling the fuel tanks with the carrier, the fuel tanks restricted to the carrier by the fastening members.

### CROSS-REFERENCE TO RELATED APPLICATION

The present application claims priority to Korean Patent Application Number 10-2007-0131810 filed Dec. 15, 2007, the entire contents of which application is incorporated herein for all purposes by this reference.

### BACKGROUND OF THE INVENTION

1. Field of the Invention

The present invention relates to a mounting structure of a fuel tank of a compressed natural gas bus, and more particularly, to a mounting structure of a fuel tank of a compressed natural gas bus in which a plurality of fuel tanks mounted on a carrier are arranged in a longitudinal direction of a vehicle body, and both ends of each fuel tank is mounted to face a traverse direction of the vehicle body and configured to be restricted by binding bands arranged in the carrier in a straight line form in the longitudinal direction of the vehicle body.

2. Description of Related Art

Generally, approximately several fuel tanks storing compressed natural gas are provided in a vehicle using the compressed natural gas as fuel.

As shown in FIGS. 1 and 2, a fuel tank 1 is fixed and mounted on a carrier 3 by binding bands 2 and carrier 3 is fixed and installed on a roof panel 4.

Total five fuel tanks 1 fixed and mounted on carrier 3 are arranged in a traverse direction of a vehicle body, i.e., the longitudinal axis of the fuel tanks 1 are in parallel to longitudinal axis of the vehicle body. In this construction, five fuel tanks 1 are arranged so that both ends of each fuel tank face a longitudinal direction of the vehicle body.

Both ends of each fuel tank 1 aligned in the longitudinal direction of the vehicle body are restricted by binding bands 2 arranged in the traverse direction of the vehicle body, whereby fuel tanks I arranged on carrier 3 are fixed and installed.

That is, one fuel tank 1 is restricted by two or three binding bands 2. Two binding bands 2 restrict fuel tank 1 by binding both ends of each fuel tank 1.

Referring to FIG. 3, a mounting structure of a conventional fuel tank 1 will be now described.

Carrier 3 includes a plurality of support frames 5 connected to carrier 3 in a longitudinal direction of carrier 3. Fuel tanks 1 are received between the support frames 5.

Since the support frames 5 are equally spaced in the traverse direction of carrier 3, loads P2 of fuel tanks 1 acting on carrier 3 act on the both traverse ends and a center portion of the vehicle body through the support frames 5.

Load supporting points P1 of a roof panel 4 against a load of a carrier 3 are disposed at both traverse ends of a vehicle body.

The load supporting points P1 are place wherein a side member forming a frame of the vehicle body.

In particular, load P2 of fuel tank 1 acting on the center portion between the both traverse ends of the vehicle body is larger than load P2 of fuel tank 1 acting on the both traverse ends of the vehicle body.

That is, in case of load P2 of fuel tank 1 acting on carrier 3, load P2 of fuel tank 1 acts on the both traverse ends of the vehicle body, while load P2 of fuel tank 1 acting on center portion between the both traverse ends is three times larger than load P2 of fuel tank 1 acting on the both traverse ends of the vehicle body as shown in FIG. 3.

As described above, when larger load P2 of fuel tank 1 acts on the center portion than on the both traverse ends of the vehicle body, the center portion is distant from load supporting points P1 of roof panel 4. Therefore, a moment M1 having large force at the both traverse ends of the vehicle body is generated in carrier 3, whereby cracks frequently occur on roof panel 4.

That is, load supporting points P1 of roof panel 4 against load of carrier 3 are disposed at the both traverse ends of the vehicle body, but load P2 of fuel tank 1 acting on carrier 3 is the larger at the center portion rather than the both traverse ends of the vehicle body.

Therefore, the center portion of carrier 3 receives the larger load in a traverse direction of the vehicle body and has force to drop down, while the both ends of carrier 3 has force to lift up.

Accordingly, roof panel 4 coupled with the both ends of carrier 3 in the traverse direction of the vehicle body intends to restrict the both ends of carrier 3 from lifting up. Since such restriction force is not larger than the lift-up force of the both traverse ends of carrier 3, the cracks frequently occur on roof panel 4.

In order to prevent the cracks from occurring on roof panel 4, an additional reinforcing member should be installed at the both traverse ends of the vehicle body, but when the additional reinforcing member is installed, a load increases. Further, if the load increases, a load acting on roof panel 4 increases as much, whereby the cracks still occur on roof panel 4.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a mounting structure of a fuel tank of a compressed natural gas bus in which the mounting structure of the fuel tank is enhanced so that a load of the fuel tank acts on a portion of a carrier adjacent to load supporting points of a roof panel against a load of the carrier, whereby it is possible to reduce the magnitude of moments of the carrier as possible, thereby preventing cracks from occurring on the roof panel.

In an aspect of the present invention, a mounting structure of a fuel tank may include a carrier fixed and mounted onto a roof panel of a vehicle body, fuel tanks sequentially arranged in a longitudinal direction of the vehicle body, wherein both end portions of each fuel tank are configured to be aligned in a traverse direction of the vehicle body, and/or fastening members coupling the fuel tanks with the carrier, the fuel tanks restricted to the carrier by the fastening members.

The mounting structure may further include support frames connecting the carrier in a longitudinal direction thereof, wherein each end portion of the fuel tanks is coupled to the support frames by the fastening members.

The fastening members may be binding bands, wherein the binding bands are aligned to face the traverse direction of the vehicle body.

The fastening members may be provided to the carrier, configured to be in a straight line along the longitudinal direction of the vehicle body, and disposed at left and right sides of the carrier with respect to a center longitudinal axis of the carrier. The fastening members may be disposed adjacent to a load supporting point. The fastening members may be disposed substantially symmetric with respect to the center longitudinal axis of the carrier at the left and right sides of the carrier in the traverse direction of the vehicle body.

The fastening members may be provided to the carrier, configured to be substantially in a straight line along the longitudinal direction of the vehicle body, and disposed at left and right sides of the carrier with respect to a center longitudinal axis of the carrier. The fastening members are disposed adjacent to a load supporting point. The fastening members may be disposed substantially symmetric with respect to the center longitudinal axis of the carrier at the left and right sides of the carrier in the traverse direction of the vehicle body.

The carrier may be configured to have upper contour of the roof panel.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of exemplary fuel tanks mounted on a roof panel.

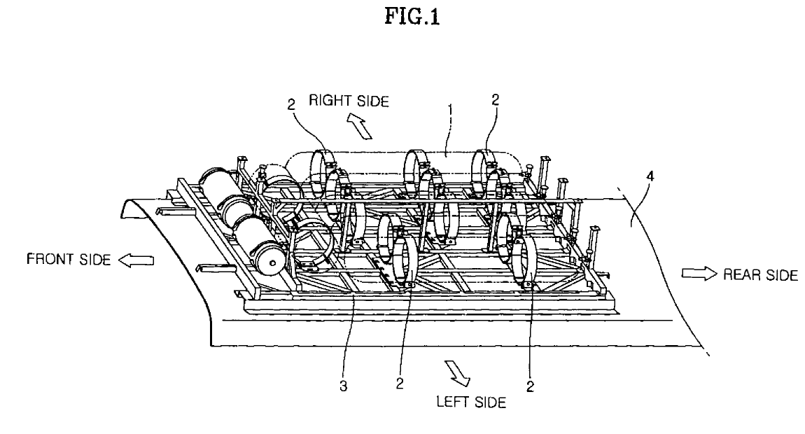

FIG. 2 is a plane view of FIG. 1.

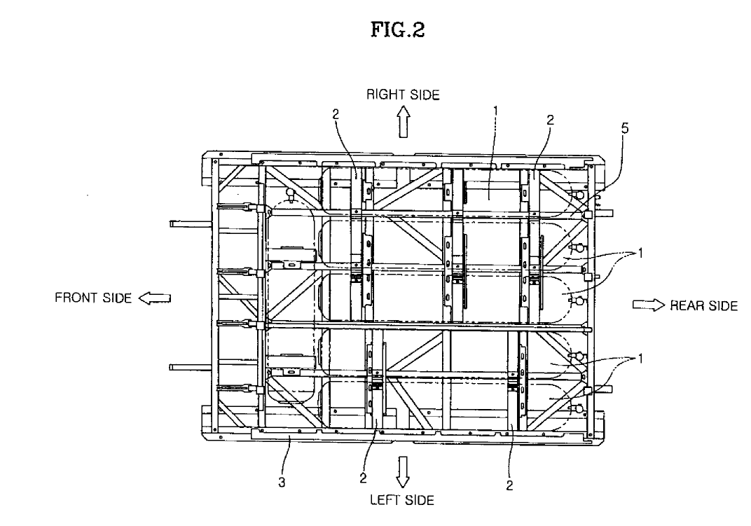

FIG. 3 is a side view of FIG. 1.

FIG. 4 is a perspective view of exemplary fuel tanks mounted on a roof panel according to the present invention.

FIG. 5 is a plane view of FIG. 4.

FIG. 6 is a side view of FIG. 4.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In an exemplary embodiment of the present invention, a vehicle using compressed natural gas (CNG) as fuel has a plurality of fuel tanks storing the compressed natural gas generally mounted on a roof panel.

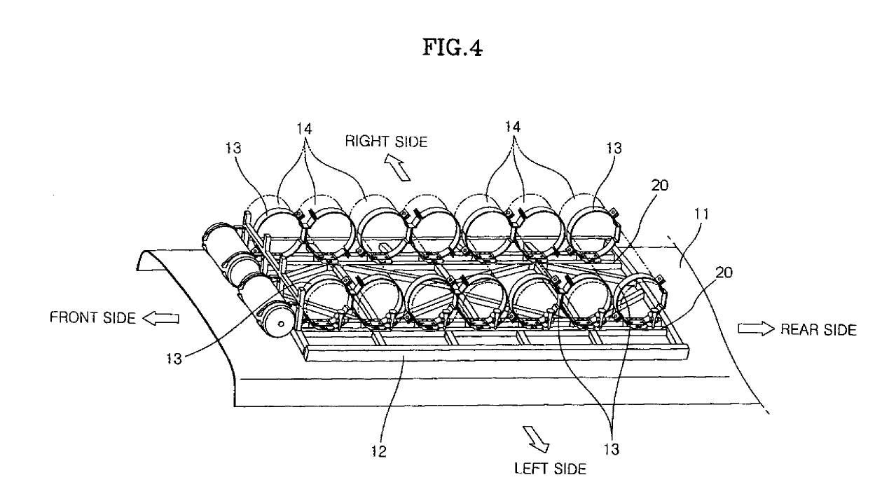

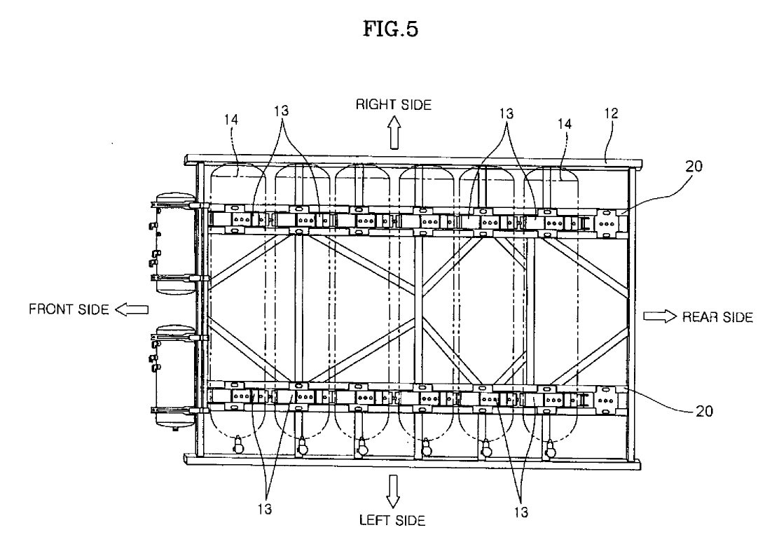

As shown in FIGS. 4 and 5, a carrier 12 is fixed and mounted on a roof panel 11 of a compress natural gas bus and a plurality of fuel tanks 14 are restricted and fixed onto carrier 12 by binding bands 13 provided in carrier 12.

In an exemplary embodiment of the present invention, fuel tanks 14 are sequentially arranged in a longitudinal direction of a vehicle body and both ends of each fuel tank 14 is disposed in a traverse direction of the vehicle body.

The both ends of fuel tank 14 aligned in the traverse direction of the vehicle body is restricted and fixed to carrier 12 by binding bands 13 of carrier 12. In particular, the carrier 12 includes a support frames 20 aligned in a longitudinal direction of the carrier 12. The fuel tanks 14 are mounted onto the support frame 12 so that all loads of the fuel tank 14 are applied to the support frames 20.

Binding bands 13 are provided in carrier 12 so that binding bands 13 are arranged in a straight line form in a longitudinal direction of the vehicle body while being disposed on the support frames 20 at left and right portions of carrier 12 in the traverse direction of the vehicle body.

In an exemplary embodiment of the present invention, the binding bands 13 may be disposed on the support frames 20 positioned symmetric at left and right portions of carrier 12 in the traverse direction of the vehicle body.

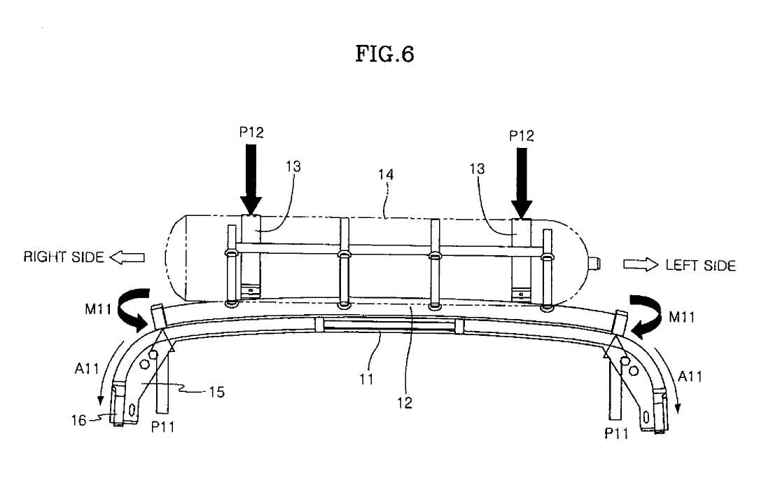

Referring to FIG. 6, a mounting structure of fuel tank 14 according to an exemplary embodiment of the present invention will be described hereinafter.

A gusset 15 is provided to the portion where roof panel 11 is connected to a side frame 16. Gusset 15 reinforces a stiffness of the connecting portion.

First, load supporting points P11 of roof panel 11 acting against a load of carrier 12 are positioned at both traverse ends of the vehicle body.

A load P12 of fuel tank 14 acting on carrier 12 by the support frame 20 acts on both ends of fuel tank 14 restricted by binding bands 13.

Since the both ends of fuel tank 14 are installed to be aligned in the traverse direction of the vehicle body and mounted onto the support frame 20 connected to the carrier 12 in the longitudinal direction thereof, wherein the support frame 20 is disposed near to the load supporting points P11, load P12 of fuel tank 14 acts adjacent to load supporting points P11 of roof panel 11.

As described above, if load P12 of fuel tank 14 acting on carrier 12 acts on the portion adjacent to load supporting points P11, load P12 of fuel tank 14 transmitted to roof panel 11 through carrier 12 is effectively diffused through a side member forming a frame of a vehicle body as indicated by an arrow A11 shown in FIG. 6.

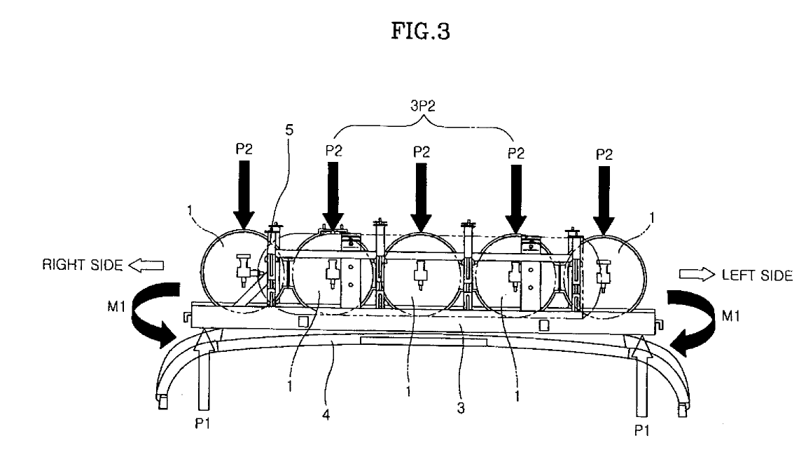

As a result, the magnitude of a moment M11 generated at both left and right ends of carrier 12 positioned in the traverse direction of the vehicle body can be remarkably reduced in comparison with a conventional structure described with reference to FIG. 3, thereby preventing cracks from occurring on roof panel.

According to various aspects of the present invention, since a load of a fuel tank acting on a carrier acts on a portion adjacent to load supporting points of a roof panel, additional reinforcing members are not installed at the both traverse ends of the vehicle body. It is also possible to remarkably reduce the magnitude of moments generated at both left and right ends of the carrier, thereby preventing cracks from occurring on the roof panel. Furthermore it is possible to prevent the cracks from occurring on the roof panel, whereby it is possible to save manufacturing cost, reduce a weight, and improve fuel efficiency.

For convenience in explanation and accurate definition in the appended claims, the terms “front”, “rear”, “left”, and “right” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A mounting structure of a fuel tank, comprising:
a carrier fixed and mounted onto a roof panel of a vehicle body;
fuel tanks sequentially arranged in a longitudinal direction of the vehicle body, wherein both end portions of each fuel tank are configured to be aligned in a traverse direction of the vehicle body; and
fastening members coupling the fuel tanks with the carrier, the fuel tanks restricted to the carrier by the fastening members.

2. The mounting structure as defined in claim 1, further including support frames connecting the carrier in a longitudinal direction thereof, wherein each end portion of the fuel tanks is coupled to the support frames by the fastening members.

3. The mounting structure as defined in claim 1, wherein the fastening members are binding bands.

4. The mounting structure as defined in claim 3, wherein the binding bands are aligned to face the traverse direction of the vehicle body.

5. The mounting structure as defined in claim 1, wherein the fastening members are provided to the carrier, configured to be substantially in a straight line along the longitudinal direction of the vehicle body, and disposed at left and right sides of the carrier with respect to a center longitudinal axis of the carrier.

6. The mounting structure as defined in claim 5, wherein the fastening members are disposed adjacent to a load supporting point.

7. The mounting structure as defined in claim 5, wherein the fastening members are disposed substantially symmetric with respect to the center longitudinal axis of the carrier at the left and right sides of the carrier in the traverse direction of the vehicle body.

8. The mounting structure as defined in claimed 1, further including a gusset provided to a portion where the roof penal is connected to a side frame.

9. The mounting structure as defined in claim 1, wherein the carrier is configured to have upper contour of the roof panel.

10. A compressed natural gas bus comprising the mounting structure as defined in claim 1.
